(19) United States
(12) Patent Application Publication
(10) Pub. No.: US 2026/0234371 A1
(43) Pub. Date: Aug. 13, 2026

(54) ROOM TEMPERATURE CURABLE COMPOSITION WITH NON-TIN CATALYST

(71) Applicant: Momentive Performance Materials Inc., Niskayuna, NY (US)

(72) Inventors: Subrata MANDAL, Bangalore (IN); Vinodh RAJENDRA, Ballston Spa, NY (US); Praveen MISHRA, Bangalore (IN); Harikrishna EROTHU, Andhra (IN); Smitha PANGUNNI, Bangalore (IN); Cristian DE SANTIS, Duisburg (DE)

(21) Appl. No.: 19/471,412

(22) PCT Filed: Apr. 10, 2024
(86) PCT No.: PCT/US2024/023789

§ 371 Date: Oct. 1, 2025

(30) Foreign Application Priority Data
Apr. 11, 2023 (IN) 202311026896

(51) Int. Cl. C08K 5/56; C08K 3/36; C08K 5/00; C08K 5/5415; C08K 5/544; C08K 9/06; C08L 83/06

(52) U.S. Cl. CPC C08K 5/56; C08K 3/36; C08K 5/0025; C08K 5/5415; C08K 5/544; C08K 9/06; C08L 83/06; C08K 2201/014

(57) ABSTRACT

A condensation curable silicone composition is shown and described herein. The condensation curable composition comprises (i) an organopolysiloxane comprising a hydrolyzable functional group and/or a condensation curable functional group; (ii) a crosslinker; (iii) a non-tin, metal-based catalyst comprising a metal center selected and an organic ligand, the organic ligand present in a molar amount sufficient to balance the charge of the metal center; (iv) an adhesion promoter comprising (a) a first adhesion promoter selected from a secondary amino silane, and (b) a second adhesion promoter other than a secondary amino silane; and (v) an additive selected from an organic acid, water, or a combination thereof. In embodiments, the metal catalyst is selected from a bismuth, zinc, titanium, aluminum, or zirconium-based compound.

### FIELD OF INVENTION

The present invention relates to a curable polyorganosiloxane composition. In particular, the present invention relates to a polyorganosiloxane composition that is moisture curable at room temperature using a non-tin catalyst.

### BACKGROUND

Moisture curable polyorganosiloxane compositions are known in the art. Such compositions are employed to provide cured materials suitable for use in a variety of applications including, for example, as adhesives, coatings, and the like. These compositions can be provided as one or two-part systems. The systems generally comprise a silicone polymer having hydrolyzable silyl functionality and a catalyst. Upon exposure to a moist atmosphere, the silyl groups react with water to form silanol groups which, in turn, condense to form a cured siloxane network, where the condensation is facilitated or promoted by the catalyst. Silicone polymer systems, however, typically cure slowly, i.e., after a few days to a few weeks of exposure to a moist atmosphere.

Moisture curable polyorganosiloxane compositions are cured with a catalyst that is selected from materials such as metal complexes and/or non-metal-based catalysts such as amines, acids, and the like. Organotin compounds are among the most widely used catalysts to promote condensation curing. Organotin catalysts provide some of the most effective curing to the extent that such catalysts promote curing in a manner that provides a material excellent curing properties including, for example, favorable tack free time (TFT), deep section curing (DSC), and adhesion to certain substrates.

Tin materials, including organotin catalysts, have faced scrutiny over the years as potentially hazardous materials. There has been more consideration in many regions and countries to regulate the use of such materials.

With the prospect of stricter regulations on the use of tin-based materials, attempts have been made to find other catalysts to use with or as a replacement to tin compounds. Alternative catalysts have been sought using metal-based compounds other than tin-based compounds, i.e., non-tin catalysts, as well as non-metal based catalysts. The prior non-tin catalysts solutions may provide some advantages and some disadvantages in the properties achieved in the products formulated with such catalysts. Some catalysts may exhibit decent curing and adhesion properties, but the cured products may exhibit yellowing. The prior non-tin catalyst solutions, however, have not been found to provide the overall robust curing, and the non-tin catalyst compositions are generally not able to meet all the required properties form a product development perspective. In particular, prior non-tin-based compositions may not be able to achieve sufficient properties across several key categories including fast tack free time (TFT), quick deep section cure (DSC), and quick bulk cure (Hardness), while still exhibiting good adhesion to various substrates.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a condensation curable silicone composition comprising a non-tin catalyst that provides a cured material exhibiting excellent properties including, but not limited to, fast tack free time, deep section cure, bulk cure, and/or adhesion. In aspects, the composition provides a cured material with excellent properties across all these categories.

In one aspect, the condensation curable silicone composition comprises a non-tin metal-based catalyst, an adhesion promoter, and an additive selected from an organic acid and/or water.

In one embodiment, the composition comprises The composition comprises (i) a polymer comprising siloxane groups with hydrolyzable and condensation curable functional groups, (ii) a non-tin metal based catalyst comprising a metal center and organic ligands, (iii) an adhesion promoter comprising (a) a first adhesion promoter selected from a secondary amino silane, and (b) a second adhesion promoter selected from an adhesion promoter other than a secondary amino silane, and (iv) an additive selected from an organic acid and/or water.

In one aspect, provided is a condensation curable silicone composition comprising:
(i) an organopolysiloxane comprising a silanol and/or a hydrolyzable functional group;
(ii) a crosslinker
(iii) a non-tin, metal-based catalyst comprising a metal center and an organic ligand, the organic ligand present in a molar amount sufficient to balance the charge of the metal center;
(iv) an adhesion promoter comprising (a) a first adhesion promoter selected from a secondary amino silane, and (b) a second adhesion promoter other than a secondary amino silane; and
(v) an additive selected from an organic acid, water, or a combination thereof.

In one embodiment, the second adhesion promoter is selected from a primary amino silane, a tertiary amino silane, a cyanurate, an isocyanurate, or a combination of two or more thereof.

In one embodiment of the composition in accordance with any of the previous embodiments, the secondary amino silane is selected from a compound of the formula:

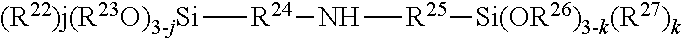

R²², R²³, R²⁶, and R²⁷ are independently selected from a C1-C20 monovalent hydrocarbon; R²⁴ is selected from a divalent C1-C20 hydrocarbon; and j and k are independently selected from 0-2.

In one embodiment, the secondary amino silane is bis(gamma-trimethoxysilylpropyl) amine.

In one embodiment of the composition in accordance with any of the previous embodiments, wherein the second adhesion promoter is selected from an aminoalkyltrialkoxysilane, an aminoalkyl(alkyldialoxysilane), a tris(alkyltrialkoxysilyl)amine, a N(beta-aminoalkyl)-gamma-aminoalkyl trialkoxysilane, a N(beta-aminoalkyl)-gamma-aminodialkyl dimethoxysilane, a tris(alkyltrialkoxysilyl)cyanurate, a tris(alkyltrialkoxysilyl)isocyanurate, or a combination of two or more thereof.

In one embodiment in accordance with any of the previous embodiments, the first adhesion promoter is selected from a a compound of the formula:

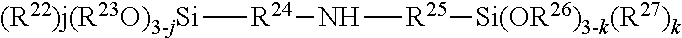

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from an aminoalkyltrialkoxysilane, an aminoalkyl(alkyldialoxysilane), a tris(alkyltrialkoxysilyl)amine, or combination of two or more thereof.

In one embodiment in accordance with any of the previous embodiments, the first adhesion promoter is selected from a a compound of the formula:

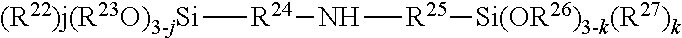

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from a N(beta-aminoalkyl)-gamma-aminoalkyl trialkoxysilane, a N(beta-aminoalkyl)-gamma-aminodialkyl dimethoxysilane, or a combination thereof.

In one embodiment in accordance with any of the previous embodiments, the first adhesion promoter is selected from a a compound of the formula:

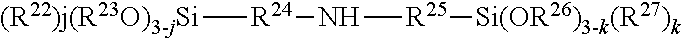

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from a tris(alkyltrialkoxysilyl)cyanurate, a tris(alkyltrialkoxysilyl)isocyanurate, or a combination thereof.

In one embodiment, the first adhesion promoter is selected from a a compound of the formula:

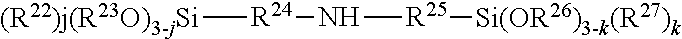

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from a (i) an aminoalkyltrialkoxysilane, an aminoalkyl(alkyldialoxysilane), or a tris(alkyltrialkoxysilyl)amine, a N(beta-aminoalkyl)-gamma-aminoalkyl trialkoxysilane, a N(beta-aminoalkyl)-gamma-aminodialkyl dimethoxysilane, or a combination of two or more thereof, and/or (ii) tris(alkyltrialkoxysilyl)cyanurate, a tris(alkyltrialkoxysilyl)isocyanurate, or a combination thereof.

In one embodiment of the composition in accordance with any of the previous embodiments, the adhesion promoter (iv) is present in an amount of from about 0.1 wt. % to about 10 wt. % based on the total weight of the composition.

In one embodiment of the composition in accordance with any of the previous embodiments, the first adhesion promoter is present in an amount of 0.05 wt. % to about 9.95 wt. % based on the total weight of the composition, and the second adhesion promoter is present in an amount of from about 0.05 wt. % to about 9.95 wt. % based on the total weight of the composition.

In one embodiment of the composition in accordance with any of the previous embodiments, the metal center of the metal-based catalyst is selected from bismuth, zinc, titanium, aluminum, or zirconium.

In one embodiment of the composition in accordance with any of the previous embodiments, wherein the organic ligand of the non-tin, metal-based catalyst is selected from a C4-C30 carboxylate. In one embodiment, the organic ligand is neodecanoate.

In one embodiment of the composition in accordance with any of the previous embodiments, the non-tin, metal-based catalyst is present in an amount of from about 0.001 wt. % to about 2.5 wt. % based on the total weight of the composition.

In one embodiment of the composition in accordance with any of the previous embodiments, the organic acid is selected from a C4-C30 organic acid.

In one embodiment of the composition in accordance with any of the previous embodiments, the organic acid is selected from at least neodecanoic acid.

In one embodiment of the composition in accordance with any of the previous embodiments, the additive (v), the organic acid can be present in an amount of from about 0 wt. % to about 2 wt. %, and water can be present in an amount of from about 0 wt. % to about 1 wt. %, with the proviso that the wt. % of organic acid+the wt. % of water is greater than 0.

In one embodiment of the composition in accordance with any of the previous embodiments, the additive (v) is provided as a diluent for the non-tin, metal-based catalyst.

In one embodiment of the composition in accordance with any of the previous embodiments, the organopolysiloxane is selected from a silanol-functional organopolysiloxane.

In one embodiment of the composition in accordance with any of the previous embodiments, the organopolysiloxane comprises a first silanol functional organopolysiloxane having a viscosity of from about 100 to about 12,000 mPa·s, and a second silanol functional organopolysiloxane having a viscosity of from about 15,000 to 100,000 mPa·s.

In one embodiment of the composition in accordance with any of the previous embodiments, the organopolysiloxane is present in an amount of from about 5 wt. % to about 95 wt. % based on the total weight of the composition.

In one embodiment of the composition in accordance with any of the previous embodiments, the condensation curable silicone composition comprises a a metal oxide.

In one embodiment, the metal oxide is selected from an untreated fumed silica or a fumed silica comprising a surface treatment.

In one embodiment, the silica is selected from a fumed silica comprising a surface treatment selected from an organosilane, an organosilazane, or a diorganocyclopolysiloxnae.

In one embodiment, the silica is present in an amount of from about 0.05 wt. % to about 2 wt. % based on the total weight of the composition.

In one embodiment of the composition in accordance with any of the previous embodiments, the composition comprises a MQ resin, where the MQ resin is present in an amount of from about 0.1 wt. % to about 10 wt. % based on the total weight of the composition.

In one embodiment of the composition in accordance with any of the previous embodiments, the composition is provided as a two-part composition comprising: (a) a first part comprising the organopolysiloxane, and (b) a second part comprising the adhesion promoter, the crosslinker, the catalyst, and the additive.

In another aspect, provided is a method of forming a cured material comprising exposing the condensation curable silicone composition of any of the previous embodiments to moisture.

The following description discloses various illustrative aspects. Some improvements and novel aspects may be expressly identified, while others may be apparent from the description.

### DETAILED DESCRIPTION

Reference will now be made to exemplary embodiments, examples of which are illustrated in the accompanying drawings. It is to be understood that other embodiments may be utilized, and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The values of ranges for a particular component can be combined to form new and non-specified ranges.

Provided is condensation curable silicone composition. The composition comprises (i) a polymer comprising siloxane groups with hydrolyzable and/or condensation curable functional groups, (ii) a non-tin metal-based catalyst comprising a metal center and organic ligands, (iii) an adhesion promoter, and (iv) an additive selected from an organic acid and/or water. The composition can include other materials suitable for curable siloxane compositions including, but not limited to, crosslinkers, chain extenders, fillers, and other such additives.

The polymer comprising siloxane groups can be selected as desired for a particular purpose or intended application. As used herein, the polymer comprising siloxane groups may also be referred to as the “siloxane polymer,” “polyorganosiloxane,” and the like. The polymer generally comprises a siloxane main chain and comprises at least one hydrolyzable and condensation curable silyl. The hydrolyzable/condensation silyl can include hydroxy functional groups.

The siloxane polymer can be a polymer comprising various silicone groups known and represented in the art as M, D, T, and Q units. M units are represented by the formula (R)₃SiO_{1/2}; D units are represented by the formula (R)₂SiO_{2/2}; T units are represented by the formula (R)SiO_{3/2}, and Q units are represented by the formula SiO_{4/2}. The R groups are generally selected from the C1-C60 hydrocarbons and a hydrolyzable group or condensation curable group. In accordance with the present composition at least one unit would comprise a hydrolyzable group or a condensation curable group. In embodiments, at least one or more R groups are —OH.

In one embodiment, the siloxane polymer is selected form a compound of the formula:

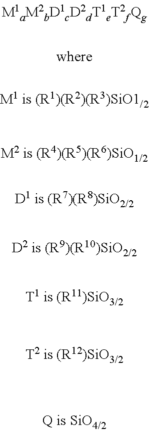

R¹, R², R³, R⁷, R⁸, and R¹¹ are each independently selected from a saturated C1-C12 alkyl (which can be substituted with one or more of a halogen (e.g., Cl, F), O, S or N atom, C5-C16 cycloalkyl, C2-C12 alkenyl, C7-C16 arylalkyl, C7-C16 alkylaryl, phenyl, C2-C4 polyalkylene ether;
R⁴, R⁵, R⁶, R⁹, R¹⁰, and R¹² are each independently selected from (a) C1-C12 alkyl (which can be substituted with one or more of a halogen (e.g., Cl, F), O, S or N atom, C5-C16 cycloalkyl, C2-C12 alkenyl, C7-C16 arylalkyl, C7-C16 alkylaryl, phenyl, C2-C4 polyalkylene ether, and (b) OH, C1-C8-alkoxy, C2-C18-alkoxyalkyl, amino, alkenyloxy, oximoalkyl, enoxyalkyl, aminoalkyl, carboxyalkyl, amidoalkyl, amidoaryl, carbamatoalkyl or a combination of two or more thereof. Exemplary groups for R2 include OH, alkoxy, alkenyloxy, alkyloximo, alkylcarboxy, alkylamido, arylamido, wherein at least one R⁴, R⁵, R⁶, R⁹, R¹⁰, and R¹² is selected from (ii);
a+b+c+d+e+f+g is a positive integer; and
b+f+d is greater than zero.

In one embodiment, the curable composition of the present invention includes at least one silanol-terminated diorganopolysiloxanes (a). In one embodiment, the silanol terminated organopolysiloxane is an MDM type siloxane. Suitable silanol-terminated diorganopolysiloxanes (a) include those of the general formula:

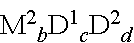

wherein b is 2, c is equal to or greater than 1, and d is zero or positive;

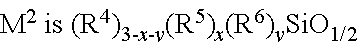

wherein x is 0, 1 or 2 and y is either 0 or 1, subject to the limitation that x+y is less than or is equal to 2, R4 is OH, R⁵ and R⁵ each independently is a monovalent hydrocarbon group up to 60 carbon atoms.
D¹ is R⁷R⁸SiO_{2/2};
wherein R⁷ and R⁸ each independently is a monovalent hydrocarbon group up to 60 carbon atoms; and
D² is R⁹R¹⁰SiO_{2/2}
wherein R⁹ and R¹⁰ each independently is a monovalent hydrocarbon group up to 60 carbon atoms.

In one embodiment, the organopolysiloxane is present in an amount of from about 5 wt. % to about 95 wt. % of the total composition, from about 20 wt. % to about 85 wt. % of the total composition, from about 30 wt. % to about 70 wt. % of the total composition, or from about 40 wt. % to about 60 wt. %.

The siloxane polymer can have a viscosity of from about 15,000 to about 100,000 m mPa pa·s, from about 20,000 to about 90,000 mPa·s, from about 30,000 mPa·s to about 80,000 mPa·s, or from about 40,000 mPa·s to about 70,000 mp mPa a s.

The organopolysiloxane can be provided by or otherwise comprise two or more organopolysiloxanes of different make up in terms of groups, functionality, size, and/or viscosity can be employed. In one embodiment, the siloxane polymer comprises a first siloxane of a first viscosity, and a second siloxane of a second viscosity. In one embodiment, the first siloxane has a viscosity of from about 100 to about 12,000 mPa·s, from about 500 to about 10,000 mPa·s, from about 1,000 to about 7,500 mPa·s, or from about 2,500 to about 5,000 mPa·s, and the second siloxane has a viscosity of from about 15,000 to about 100,000 mPa·s, from about 20,000 to about 90,000 mPa·s, from about 25,000 to about 80,000 mPa·s, or from about 30,000 to about 75,000 mPa·s. The first siloxane can be present in an amount of from about 1 wt. % to about 60 wt. %, from about 10 wt. % to about 50 wt. %, or from about 20 wt. % to about 40 wt. % based on the total weight of the siloxane, and the second siloxane can be present in an amount of from about 40 wt. % to about 99 wt. %, from about 50 wt. % to about 90 wt. %, or from about 60 wt. % to about 80 wt. % based on the total weight of the siloxane.

The composition can also include a crosslinker. As used herein, the term crosslinker includes a compound including an additional reactive component having at least two hydrolyzable groups and less than three silicon atoms per molecule not defined under the siloxane polymer (i). In one embodiment, the crosslinker or chain extender may be chosen from an alkoxysilane, an alkoxysiloxane, an oximosilane, an oximosiloxane, an enoxysilane, an enoxysiloxane, an aminosilane, a carboxysilane, a carboxysiloxane, an alkylamidosilane, an alkylamidosiloxane, an arylamidosilane, an arylamidosiloxane, an alkoxyaminosilane, an alkaryaminosiloxane, an alkoxycarbamatosilane, an alkoxycarbamatosiloxane, an imidatosilane, a ureidosilane, an isocyanatosilane, a thioisocyanatosilane, and combinations of two or more thereof.

Examples of suitable crosslinkers include, but are not limited to, tetraethylorthosilicate (TEOS); methyltrimethoxysilane (MTMS); methyltriethoxysilane; vinyltrimethoxysilane; vinyltriethoxysilane; methylphenyldimethoxysilane; 3,3,3-trifluoropropyltrimethoxysilane; methyltriacetoxysilane; vinyltriacetoxysilane; ethyltriacetoxysilane; di-butoxydiacetoxysilane; phenyltripropionoxysilane; methyltris(methylethylketoxime)silane; vinyltris(methylethylketoxime)silane; 3,3,3-trifluoropropyltris(methylethylketoxime)silane; methyltris(isopropenoxy)silane; vinyltris(isopropenoxy)silane; ethylpolysilicate; dimethyltetraacetoxydisiloxane; tetra-n-propylorthosilicate; methyldimethoxy(ethylmethylketoximo)silane; methylmethoxybis-(ethylmethylketoximo)silane; methyldimethoxy(acetaldoximo)silane; methyldimethoxy(N-methylcarbamato)silane; ethyldimethoxy(N-methylcarbamato)silane; methyldimethoxyisopropenoxysilane; trimethoxyisopropenoxysilane; methyltri-iso-propenoxysilane; methyldimethoxy(but-2-ene-2-oxy)silane; methyldimethoxy(1-phenylethenoxy)silane; methyldimethoxy-2(1-carboethoxypropenoxy)silane; methylmethoxydi-N-methylaminosilane; vinyldimethoxymethylaminosilane; tetra-N,N-diethylaminosilane; methyldimethoxymethylaminosilane; methyltricyclohexylaminosilane; methyldimethoxyethylaminosilane; dimethyldi-N,N-dimethylaminosilane; methyldimethoxyisopropylaminosilane; dimethyldi-N,N-diethylaminosilane; ethyldimethoxy(N-ethylpropionamido)silane; methyldimethoxy(N-methylacetamido)silane; methyltris(N-methylacetamido)silane; ethyldimethoxy(N-methylacetamido)silane; methyltris(N-methylbenzamido)silane; methylmethoxybis(N-methylacetamido)silane; methyldimethoxy(caprolactamo)silane; trimethoxy(N-methylacetamido)silane; methyldimethoxyethylacetimidatosilane; methyldimethoxypropylacetimidatosilane; methyldimethoxy(N,N′,N′-trimethylureido)silane; methyldimethoxy(N-allyl-N′,N′-dimethylureido)silane; methyldimethoxy(N-phenyl-N′,N′-dimethylureido)silane; methyldimethoxyisocyanatosilane; dimethoxydiisocyanatosilane; methyl dimethoxythioisocyanatosilane; methylmethoxydithioisocyanatosilane, or combinations of two or more thereof.

In one embodiment of the present invention, the crosslinker is present in an amount of from about 0.1 wt. % to about 10 wt. % of the total composition, from about 0.3 wt. % to about 5 wt. % of the total composition, or from about 0.5 wt. % to about 1.5 wt. % of the total composition.

The composition includes an adhesion promoter. The adhesion promoter is generally selected from the family of amino silane compounds, cyanurate-containing, and/or isocyanurate-containing compounds. The adhesion promoter, in one embodiment, is selected from an amino silane. The amino silane can be a primary amino silane, a secondary amino silane, a tertiary amino silane, or a mixture of two or more thereof. In one embodiment, the adhesion promoter is selected from at least a secondary amino silane.

In In one embodiment, the adhesion promoter component (D) is chosen from an aminoalkyltrialkoxysilane, an aminoalkylalkyldialkoxysilane, a bis(alkyltrialkoxysilyl)amine, a tris(alkyltrialkoxysilyl)amine, N(beta-aminoalkyl)-gamma-aminoalkyl trialkoxysilane, a N(beta-aminoalkyl)-gamma-aminodialkyl dimethoxysilane a tris(alkyltrialkoxysilyl)cyanuarate, and a tris(alkyltrialkoxy-silyl) isocyanuarate, or a combination of two or more thereof.

The amino silane can be of the formula:

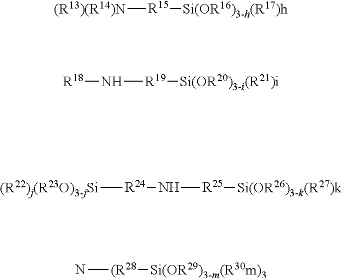

where R¹³, R¹⁴ and R¹⁸ are independently selected from H or a monovalent C1-C20 hydrocarbon; R¹⁶, R¹⁷, R²⁰, R²¹, R²², R²³, R²⁶, R²⁷, R²⁹, and R³⁰ are independently selected from a C1-C20 monovalent hydrocarbon; R¹⁵, R¹⁹, R²⁴, and R²⁸ are independently selected from a divalent C1-C20 hydrocarbon; h, i, j, k, and m are independently selected from 0-2. In one embodiment, R¹³, R¹⁴, R¹⁸, R¹⁶, R¹⁷, R²⁰, R²¹, R²², R²³, R²⁶, R²⁷, R²⁹, and R³⁰ are selected from a C1-C20 alkyl, a C2-C15 alkyl, a C4-C10 alkyl, or a C6-C8 alkyl. In one embodiment R¹³, R¹⁴, R¹⁸, R¹⁶, R¹⁷, R²⁰, R²¹, R²², R²³, R²⁶, R²⁷, R²⁹, and R³⁰ are independently selected from a C1-C4 alkyl. In one embodiment, R¹⁵, R¹⁹, R²⁴, and R²⁸ are independently selected from a C1-C20 alkylene, a C2-C15 alkylene, a C3-C10 alkylene, or a C4-C8 alkylene.

Examples of suitable adhesion promoters include, but are not limited to, N-(2-aminoethyl)aminopropyltrimethoxysilane gamma-aminopropyltriethoxysilane, N(beta-aminoethyl) gamma-aminopropyltrimethoxy-silane, N(beta-aminoethyl) gamma-aminopropylmethyldimethoxy-silane, gamma-aminopropyltrimethoxysilane, bis(gamma-trimethoxysilypropyl)amine, N-phenyl-gamma-aminopropyltrimethoxysilane, triaminofunctionaltrimethoxysilane, gamma-aminopropylmethyldimethoxysilane, gamma-aminopropylmethyldiethoxysilane, methacryloxypropyltrimethoxysilane, methyl aminopropyltrimethoxysilane, gamma-glycidoxypropylethyldimethoxysilane, gamma-glycidoxypropyltrimethoxysilane, gamma-glycidoxyethyltrimethoxysilane, gamma-(3,4-epoxycyclohexyl)ethyltrimethoxysilane, beta-(3,4-epoxycyclohexyl)ethylmethyl-dimethoxysilane, epoxylimonyltrimethoxysilane, isocyanatopropyltriethoxysilane, isocyanatopropyltrimethoxysilane, isocyanatopropylmethyldimethoxysilane, beta-cyano-ethyl-trimethoxysilane, gamma-acryloxypropyl-trimethoxy-silane, gamma-methacryloxypropyl-methyldimethoxysilane, alpha, omega-bis-(aminoalkyl-diethoxysilyl)-polydimethylsiloxanes, alpha, omega-bis-(aminoalkyl-diethoxysilyl)-octa-methyltetrasiloxane, 4-amino-3,3,-dimethyl-butyl-trimethoxysilane, and N-ethyl-3-tri-methoxy-silyl-2-methylpropanamine, 3-(diethyl-aminopropyl)-trimethoxysilane, 3-aminopropyltrimethoxysilane, 3-aminopropyltriethoxysilane, 3-aminopropyltrismethoxy-ethoxyethoxysilane, 3-aminopropyl-methyl-diethoxysilane, N-methyl-3-aminopropyltrimethoxysilane, N-butyl-3-aminopropyltrimethoxysilane, 3-mercaptopropyltrimethoxysilane, 3-mercaptopropyltriethoxysilane, 3-mercaptopropyl-methyl-dimethoxysilane, (N-Gyclohexylaminomethy)methyldi-ethoxysilane, (N-cyclohexylaminomethyl)triethoxysilane, (N-phenylaminomethyl)methyldimethoxysilane, (N-phenylaminomethyl)trimethoxysilane, N-ethyl-aminoisobutyltrimethoxysilane, 4-amino-3,3-dimethylbutyltrimethoxysilane, combinations of two or more thereof, and the like.

The adhesion promoter can be present in an amount of from about 0.1 wt. % to about 10 wt. %, from about 1 wt. % to about 5 wt. %, or from about 1.5 wt. % to about 4 wt. % based on the total weight of the composition.

In one embodiment, the composition comprises two or more adhesion promoters, including a first adhesion promoter selected from a secondary amino silane, and a second adhesion promoter selected that is other than a secondary amino silane. In one embodiment, the secondary amino silane is a bis(alkyltrialkoxysilyl)amine, and the second adhesion promoter is selected from a primary amino silane, a tertiary amino silane, a cyanurate based silane, and/or a isocyanurate based silane.

In one embodiment, the first adhesion promoter is selected from a a compound of the formula.

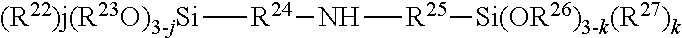

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from an aminoalkyltrialkoxysilane, an aminoalkyl(alkyldialoxysilane), a tris(alkyltrialkoxysilyl)amine, or combination of two or more thereof.

In one embodiment, the first adhesion promoter is selected from a a compound of the formula:

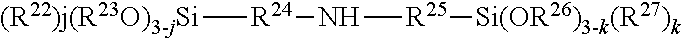

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from a N(beta-aminoalkyl)-gamma-aminoalkyl trialkoxysilane, a N(beta-aminoalkyl)-gamma-aminodialkyl dimethoxysilane, or a combination thereof.

In one embodiment, the first adhesion promoter is selected from a a compound of the formula:

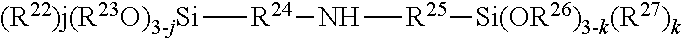

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from a tris(alkyltrialkoxysilyl)cyanurate, a tris(alkyltrialkoxysilyl)isocyanurate, or a combination thereof.

In one embodiment, the first adhesion promoter is selected from a a compound of the formula:

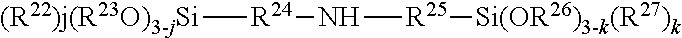

R²², R²³, R²⁶, and R²⁷ are independently selected from a C1-C20 monovalent hydrocarbon; R²⁴ is selected from a divalent C1-C20 hydrocarbon; and j and k are independently selected from 0-2; and
the second adhesion promoter is selected from a (i) an aminoalkyltrialkoxysilane, an aminoalkyl(alkyldialoxysilane), or a tris(alkyltrialkoxysilyl)amine, a N(beta-aminoalkyl)-gamma-aminoalkyl trialkoxysilane, a N(beta-aminoalkyl)-gamma-aminodialkyl dimethoxysilane, or a combination of two or more thereof, and/or (ii) tris(alkyltrialkoxysilyl)cyanurate, a tris(alkyltrialkoxysilyl)isocyanurate, or a combination thereof.

In embodiments, the first amino silane is selected from bis(propyltrimethoxysilane)amine. The first adhesion promoter can be present in an amount of from about 0.05 wt. % to about 9.95 wt. %, from about 1 wt. % to about 5 wt. %, or from about 1.5 wt. % to about 3.5 wt. % based on the total weight of the adhesion promoter, and the second adhesion promoter can be present in an amount of from about 0.05 wt. % to about 9.95 wt. %, from about 1 wt. % to about 5 wt. %, or from about 1.5 wt. % to about 3.5 wt. % based on the total weight of the adhesion promoter.

The catalyst is selected from a non-tin, metal-based catalyst. Generally, the metal-based catalyst is selected from a compound having a metal center and an organic ligand. The metal can be selected from a variety of metal-based materials with the proviso that the metal does not include tin. In one embodiment, the metal can be selected from a metal or oxometal cation. In one embodiment, the metal or oxometal cation can comprise a metal selected from scandium, yttrium, lanthanum, titanium, zirconium, hafnium, vanadium, niobium, tantalum, chromium, molybdenum, tungsten, manganese, iron, cobalt, nickel, copper, zinc, aluminum, gallium, indium, germanium, tin, lead, antimony and bismuth. In one embodiment, the metal is selected from bismuth, zinc, titanium, aluminum, or zirconium. The ligand can be selected from a suitable organic ligand. In embodiments, the ligand can be selected from from a diketonate, a diamine, a triamine, an aminoacetate, a nitriloacteate, a bipyridin, a glyoxime, a carboxylate, a combinatoin of two or more thereof, and the like. In one embodiment, the organic ligand is selected from a carboxylate. It will be appreciated that the organic ligand is generally provided in a molar amount corresponding to the valence state of the metal center. The metal could include fewer organic ligands provided another suitable anion is provided.

In one embodiment, the catalyst is selected from metal-based compound with a bismuth, titanium, aluminum, zirconium, or zinc metal center and an organic ligand. In one embodiment, the organic ligand is generally an anionic ligand and can be selected from a C4-C25 carboxylate, a C6-C30 carboxylate, a C8-C18 carboxylate, or a C10-C15 carboxylate. In one embodiment, the carboxylate is selected from a C4-C30-alkyl-, C7-C30-arylalkyl, C7-C30-alkylaryl, and/or a C6-C10-aryl carboxylate. The carboxylate can be a straight chain or branched. Examples of suitable carboxylate anions include, but are not limited to, pentanoate, hexanoate, heptanoate, octoate, 2-ethyl hexanoate, neodecanoate, and the like. The organic ligand is generally present to act as a counter ion, and the equivalents of ligand will depend on the valence state of the metal center (e.g., 3 for bismuth, and 2 for zinc).

Some examples of suitable catalysts include those sold under the tradename K-KAT®, REAXIS™, or TIB KAT® such as, but not limited to, K-KAT® 651 (bismuth carboxylate), K-KAT® XK 648 (zinc complex), K-KAT® 670 (zinc catalyst), REAXIS™ C3208 (bismuth carboxylate), REAXIS™ C716 (bismuth carboxylate), REAXIS™ 3202LA (bismuth octoate), REAXIS™ C616 (zinc neodecanoate), REAXIS™, REAXIS™ C708 (zinc/bismuth neodecanoate blend), REAXIS™ C716 (bismuth neodecanoate), REAXIS™ C717 (zinc/bismuth octoate blend), TIB KAT® 616 (zinc neodecanoate), TIB KAT® 620 (zinc octoate), TIB KAT® 623 (zinc acetylacetonate), TIB KAT® 634 (zinc oxalate), TIB KAT® 634 (zinc acetate), TIB KAT® 716 (bismuth carboxylate), TIB KAT® 710 (bismuth carboxylate), TIB KAT® 519 (titanium ethyl acetoacetate), TIB KAT® 851 (aluminum ethyl acetoacetate), and the like.

The catalyst is present in an amount of from about 0.001 wt. % to about 2.5 wt. %, from about 0.01 wt. % to about 1.5 wt. %, or from about 0.1 wt. % to about 1 wt. % based on the total weight of the composition.

The composition includes an additive selected from an organic acid, water, or a mixture thereof. The organic acid can be selected from a C4-C30, a C6-C25, a C8-C20, or a C10-C15 organic acid. The C4-C30 group can be straight chained or branched. In one embodiment, the organic acid is a “neo” acid, which is a highly branched aliphatic carboxylic acid. Generally, neo acids are trialkyl acetic acids, which include a tetra substituted alpha-carbon. In one embodiment, the organic acid is a C8-C30 neo acid. In one embodiment, the organic acid is selected from neopentanoic acid, neodecanoic acid, and the like. A suitable neopentanoic acid is Versatic™ Acid 5 available from Hexion, Neodecanoic acid in particular is a mix of isomers of C₁₀H₂₀O₂ having an average molecular weight of approximately 172 grams/mole. Two examples of such isomers are shown below.

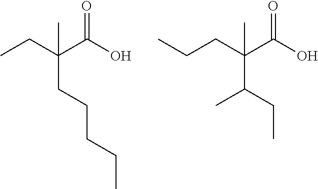

An example of a suitable neodecanoic acid is Versatic™ Acid 10 available from Hexion.

The organic acid or water additive can be separately provided or may be provided as part of a catalyst mixture. For example, the catalyst can be provided as a mixture of the catalyst material with organic acid or water as a diluent. The organic acid can be provided as part of such mixture in an amount to provide the desired level of organic acid or water in the composition when the desired amount of catalyst is added.

The organic acid can be present in an amount of from about 0 wt. % to about 2 wt. %, from about 0.1 wt. % to about 1 wt. %, or from about 0.2 wt. % to about 0.5 wt. % based on the total weight of the composition, and water can be present in an amount of from about 0 wt. % to about 1 wt. %, from about 0.1 wt. % to about 0.75 wt. %, or from about 0.2 wt. % to about 0.5 wt. % based on the total weight of the composition, with the proviso that the wt. % of organic acid plus the wt. % of water is greater than 0.

The composition optionally includes a filler. The fillers can be employed to provide various properties or features to the composition and cured product. The type and amount of filler added depends upon the desired physical properties for the cured silicone composition. In embodiments, the filler can function as a reinforcing or semi-reinforcing filler, i.e., to achieve higher tensile strength after curing having in addition the ability to increase the viscosity establish pseudoplasticity/shear thinning, and thixotropic behavior. Non-reinforcing fillers may also be provided that may function as, for example, a volume extender.

Examples of suitable fillers include, but are not limited to, ground, precipitated and colloidal calcium carbonates reinforcing silicas such as fumed silicas, precipitated silicas, silica gels, hydrophobized silicas, silica gels; crushed and ground quartz, alumina, aluminum hydroxide, titanium hydroxide, diatomaceous earth, iron oxide, carbon black and graphite or clays such as kaolin, bentonite or montmorillonite, talc, mica, and the like. The fillers can be treated or non-treated. In one embodiment, the filler is a calcium carbonate treated with a compound such as stearate or stearic acid.

In one embodiment of the present invention, the filler is a calcium carbonate filler, silica filler or a mixture thereof.

The filler can be present in the composition in an amount of from 0 wt. % to about 90 wt. % of the total composition, from about 5 wt. % to about 60 wt. % of the total composition, the amount of filler is from about 10 wt. % to about 40 wt. % of the total composition. The filler may be a single type or a mixture of two or more fillers of different chemical make, or fillers of the same chemical makeup but of different sizes, morphologies, etc.

In one embodiment, the composition comprises a metal oxide as an additive. The metal oxide can be treated or untreated. Examples of suitable metal oxides include, but are not limited to, alumina, silica, titania, ceria, iron oxide, or a mixture of two or more thereof. In one embodiment, the metal oxide is a fumed metal oxide selected from fumed alumina, fumed silica, fumed titania, fumed ceria, fumed iron oxide, or a mixture of two or more thereof in one embodiment, the metal oxide comprises a surface treatment. The surface treatment may be, for example, an organosilane, an organosilazane, or a diorganocyclopolysiloxnae. Examples of suitable surface treatment agents include, but are not limited to, hexamethylsilazane, hexamethylcyclotrisilazane, methyltrichlorosilane, dimethyldichlorosilane, trimethylmonochlorosilane, and the like. Particularly suitable silica or metal oxide materials include fumed silica or fumed metal oxides. In embodiments, the fumed silica or fumed metal oxide can have a BET surface area of from about 30 m²/g to about 500 m²/g, from about 50 m²/g to about 350 m²/g, or from about 100 m²/g to about 250 m²/g. Some examples of treated fumed silicas include, but are not limited to, AEROSIL® R812 (hexamethyldisilazane; 260 m²/g; 60), AEROSIL® R812S (hexamethyldisilazane; 220 m²/g; 65), and AEROSIL® R8200 (hexamethyldisilazane; 150 m²/g; 65).

In embodiments, the silica or metal oxide filler can be provided in an amount of from about 0.05 wt. % to about 2 wt. %, from about 0.075 wt. % to about 1 wt. %, or from about 0.1 wt. % to about 0.5 wt. % based on the total weight of the composition.

The composition can optionally include other silicone-based additives. In one embodiment, the composition can employ a polyether substituted siloxane. A polyether substituted siloxane generally comprises a siloxane type compound having a polyether pendant to one of the silicon atoms. The siloxane compound can be of the general type comprising combinations of M (Si(R)₃O_{1/2}—), D (Si(R)₂O_{2/2}—), T (Si(R)O_{3/2}—), and Q (SiO_{4/2}—) units as is known and understood in the art, where the R groups are independently selected from a monovalent hydrocarbon radical, one or more of the R groups attached to a silicone atom are substituted with a polyether group. In one embodiment, the siloxane backbone is an MDM type resin where the M and/or D units may be substituted with a polyether group. The polyether group is not particularly limited and can be selected as desired. In one embodiment, the polyether group is selected from ethylene oxide groups, polyether groups, or a combination thereof.

In one embodiment, the silicone-based additive is an alkyl-polydimethylsiloxane. The alkyl-polydimethylsiloxane may be provided as a wax material, and may comprise a polydimethylsiloxane backbone having 15-45, 20-40, or 25-30 “D” units ((Si(R)₂O_{2/2}), and a terminal alkyl group selected from a C15-C40, a C20-C35, or a C25-C30 alkyl. In embodiments, the silicone-based additive can be provided in an amount of from about 0.05 wt. % to about 2 wt. %, from about 0.075 wt. % to about 1 wt. %, or from about 0.1 wt. % to about 0.5 wt. % based on the total weight of the composition.

The composition can optionally include a hydroxy functional MQ resin. MQ resins are generally known in the art. In embodiments, the MQ resin comprises M units, represented by the formula R³¹₃SiO_{1/2} and Q units, represented by the formula SiO_{4/2}, where each R³¹ is independently selected from hydroxy or a monovalent hydrocarbon radical, provided that the resin has a silanol content of 0.2% to about 5% by weight. It is recognized that while the MQ resins are primarily made from M and Q units, there can be up to 5 mole percent of D units represented by the formula R³²₂SiO_{2/2} and T units, represent by the formula R³³SiO_{3/2}, wherein each R³¹, R³² and R³³ is independently hydroxyl or a monovalent hydrocarbon radical. Examples of suitable monovalent hydrocarbon radical include, but are not limited to, those monovalent hydrocarbon radicals having from about 1 to about 6 carbon atoms, such as alkyl radicals including methyl, ethyl, and isopropyl; alkenyl radicals including ethylene, propenyl, and hexenyl; cycloaliphatic radicals such as cyclopentyl cyclohexenyl; olefinic-containing radicals such as vinyl and allyl; and olefinic-containing radicals. In one embodiment, the monovalent hydrocarbon radical in the MQ resin is methyl.

In one embodiment, the MQ resin has a ratio of M units to Q units (an “M/Q ratio”) of less than 1.1:1, from about 0.8:1 to less than 1.1:1, or from about 0.8:1 to about 1.0:1. Silanol-functional silicone resin bends having an M:Q ratio within a selected range may be prepared by blending silicone MQ resins, one or more of which may individually have an M/Q ratio outside the preferred range.

The polyether modified siloxane and the MQ resin can each be present in an amount of from about 0 wt. % to about 10 wt. %, from about 0.1 wt. % to about 10 wt. %, from about 0.5 wt. % to about 8 wt. %, or from about 1.5 wt. % to about 6 wt. % based on the total weight of the composition.

A cured material is formed by subjecting the mixture of the components to moisture at or around room temperature (e.g., from about 18° C. to about 30° C.). The moisture can be provided by moisture from the atmosphere or from a separate addition to the mixture (e.g., the water additive may contribute to curing of the composition). The composition can be provided as a one-part or two-part composition. In one embodiment, the composition is formed by separately adding the components (or adding in groups of components) and mixing the various components together. The components can be added in any order, but it may be desirable to add the catalyst last. With condensation cure compositions, it may be desirable to provide the composition as a two-part composition with the catalyst and reactive siloxane polymers in separate parts to avoid premature reaction of the composition. In one embodiment, a two-part composition is provided as a first part (part A) comprising the silicone polymer and a filler, and a second part (part B) comprising the adhesion promoter(s), catalyst, additive (e.g., organic acid and/or water), and crosslinker.

The present compositions exhibit excellent properties including, but not limited to, tack-free time, deep-section cure, and adhesion. As understood herein the curing of sealant compositions can be expressed as the “tack-free time” or surface curing and “deep-section cure” or curing along the sealant's thickness. Tack-free time is tested by spreading a sealant to a desired thickness (e.g., 6.35 mm) on a Teflon mold and placing a 10 g stainless steel (SS) weight on the sealant at different intervals of time. The tack free time is the time when no material sticks to the surface of the weight. Alternatively, “deep-section cure” or curing along the thickness is tested based on the spread material being cut along the thickness periodically to detect the complete curing. The time taken for the material to cure completely along the thickness is called deep-section cure, also known as “thick-section cure.” Apart from visual observation the inventors have devised a method to measure the deep-section cure, more fully described herein below, by extracting the uncured material of the sealant by solvent.

In one embodiment, a composition in accordance with the present technology exhibits a tack-free time of less than 30 minutes, less than 25 minutes, less than 20 minutes, less than 15 minutes, less than 10 minutes, or less than 5 minutes. In one embodiment, a composition in accordance with the technology exhibits a tack-free time of from about 4 minutes to about 30 minutes, from about 7 minutes to about 25 minutes, from about 10 minutes to about 20 minutes, or from about 12 to about 18 minutes. In one embodiment, a composition in accordance with the present technology exhibits a tack-free time of from about 4 to about 12 minutes, from about 5 to about 10 minutes, or from about 6 to about 8 minutes.

In one embodiment, a composition in accordance with the present technology exhibits a deep-section cure of less than 30 minutes, less than 25 minutes, less than 20 minutes, or less than 15 minutes. In one embodiment, a composition in accordance with the technology exhibits a tack-free time of from about 10 minutes to about 30 minutes, from about 12 minutes to about 25 minutes, or from about 15 minutes to about 20 minutes.

The curable compositions may be used in a wide range of applications including as materials for sealing, mold making, glazing, and prototyping; as adhesives; as coatings in sanitary rooms; as joint seal between different materials, e.g., sealants between ceramic or mineral surfaces and thermoplastics; as paper release; as impregnation materials; and the like. A curable composition in accordance with the present invention may be suitable for a wide variety of applications such as, for example, a general purpose and industrial sealant, potting compound, caulk, adhesive or coating for construction use, insulated glass, structural glazing, where glass sheets are fixed and sealed in metal frame; caulks, adhesives for metal plates, car bodies, vehicles, electronic devices, and the like.

### Examples

General Method for Evaluating the Performance of Various Catalysts in Presence of Adhesion Promoter and Other Additives

20 g of a mixture of silanol polymers with two different viscosities and CaCO₃ filler was taken in a Speed Mixer cup and 0.4 g of Aminosilane (Secondary Amine) and 0.2 g of adhesion promoter (primary amine/other amine) were added followed by 0.068 g of crosslinker (n-Propyl silicate), 1.27 g of PDMS, 0.01 g of polyether based PDMS, 0.27 g of Carbon black, and finally 0.052 g of catalyst. The mixture was thoroughly mixed by spatula and then using Speed Mix (method 2350 RPM for 10 seconds).

The material was then applied on a Teflon coated surface (about 1 mm thickness) for Tack-Free Time analysis (TFT). The material was also poured into a mold with 6 mm thickness for bulk curing hardness analysis (Thickness Shore A). The material with 1 mm thickness was disposed on an Aluminum/Glass/Polycarbonate plate for adhesion studies. Bulk curing hardness (Thickness Shore A) after 24 hours & Lap shear strength (LSS) were measured after 24 hours (ASTM-3163). Temperature and Humidity were noted during every sample preparation.

General Method for Storage Stability Performance Evaluation (Ageing Study) of Various Catalysts in Presence of Adhesion Promoters and Versatic Acid—

A two-part material was prepared using part A and part B as follows: Part A is a composition with 40 g of the silanol polymers with two different viscosities, 2.54 g of PDMS, 0.54 g of Carbon black (Speed Mix for 10 sec). Part B is a mixture of 3.2 g of Aminosilane (Secondary Amine), 1.6 g of Aminosilane (Primary Amine), 0.544 g of Crosslinker (n-Propyl silicate), 0.08 g of Polyether containing PDMS, 0.416 g of Catalyst, and 0.8 g of Neodecanoic acid (Versatic acid—VA10).

The total weight of part B was 6.64 g, out of which 1.66 g (25% of Part B) was used for formulation, and the remainder of the part B solution was kept at hot oven of 70° C. for 5 days. 1.66 g of part B solution was added to part A mixture (Speed Mixer cup), and the mixture was thoroughly mixed by spatula and then using Speed Mix (2350 RPM for 10 sec) for curing. The material was then applied on a Teflon coated surface (around 1 mm thickness) for Tack-Free Time (TFT) analysis, and the material was also poured into a mold with 6 mm thickness for bulk curing hardness (Thickness Shore A) analysis. The material with 1 mm thickness was also disposed on an Aluminum/Glass/Polycarbonate plate for adhesion studies. The rest of the material was then applied on a flexible sheet (about 2 mm thickness) with about 8 mm thickness for Deep Section Cure (DSC). TFT and DSC were measured as per the standard method. The catalyzed material is cut at different time periods and is measured for its TFT within the centre. If the centre is tack free, the deep section cure is complete. If not, another cut ¼ inch away can be made at another time period until the testis complete. Bulk curing hardness (Thickness Shore A) and Lap shear strength (LSS) were measured after 24 hours.

After 5 days of part B solution at 70° C., repeated the same above procedure for measuring TFT, DSC and Adhesion performance.

The compositions analyzed are described in Tables 1 and 2:

TABLE 1

| Description | F # 1 | F # 2 | F # 3 | F # 4 | F # 5 | F # 6 | F # 7 |
|---|---|---|---|---|---|---|---|
| MOH-D-MOH (~30000 cPs | 22.63 | 22.63 | 22.63 | 22.63 | 22.63 | 22.63 | 22.63 |
| Viscosity) | | | | | | | |
| MOH-D-MOH (~3000 cPs | 24.1 | 24.1 | 24.1 | 24.1 | 24.1 | 24.1 | 24.1 |
| Viscosity) | | | | | | | |
| Silquest A-1170 (Amino-bis- | 1.8 | 1.8 | 1.8 | 1.8 | 1.8 | 1.8 | 1.8 |
| silane) | | | | | | | |
| Silquest A-597 (Isocyanurate) | | | | | | | |
| Silquest A-1110 (Aminosilane) | 0.9 | 0.9 | 0.9 | 0.9 | 0.9 | 0.9 | 0.9 |
| Crosslinker (NPS) - n- | 0.3 | 0.3 | 0.3 | 0.3 | 0.3 | 0.3 | 0.3 |
| Propylsilicate | | | | | | | |
| M-D-M (PDMS) ~10000 cPs | 4.14 | 3.97 | 4.14 | 4.14 | 4.25 | 4.14 | 4.14 |
| Viscosity | | | | | | | |
| Carbon Black | 1.21 | 1.21 | 1.21 | 1.21 | 1.21 | 1.21 | 1.21 |
| Calcium Carbonate (CaCO3) | 44.21 | 44.21 | 44.21 | 44.21 | 44.21 | 44.21 | 44.21 |
| PDMS-PPO Copolymer | 0.04 | 0.04 | 0.04 | 0.04 | 0.04 | 0.04 | 0.04 |
| (~500 cSt Viscosity) | | | | | | | |
| Additive 1 (H2O) | | 0.17 | | | | | |
| Additive 2 (Versatic Acid) | 0.44 | 0.44 | 0.44 | 0.44 | 0.33 | 0.44 | 0.44 |
| Additive 3 (Silicone MQ Resin) | | | | | | | |
| Catalyst | 0.23 K- | 0.23 K- | 0.23 K- | 0.23 K- | 0.23 Reaxis | 0.04 TIB- | 0.04 TIB- |
| | KAT-651 | KAT-651 | KAT-670 | KAT-648 | C3208 | KAT-519 | KAT-851 |
| TFT (min) | 7 | 5 | 4 | 5 | 6 | 10 | 10 |
| Bulk Hardness (Shore A) - 24 h | 32 | 30 | 31 | 30 | 32 | 30 | 29 |
| Stability - Ageing Study | >5 Days | >5 Days | >5 Days | >5 Days | >5 Days | >5 Days | >5 Days |
| (70 C./5 D) | | | | | | | |
| Adhesion Strength (Al/Al) in | 0.97 | 0.9 | 0.45 | 0.29 | 0.39 | 0.43 | 0.42 |
| MPa | | | | | | | |
| Failure Type | Cohesive | Cohesive | Cohesive | Cohesive | Cohesive | Cohesive | Cohesive |
| Adhesion Strength (Glass/PC) | 0.45 | 0.35 | 0.32 | 0.27 | 1 | 0.90 | 0.52 |
| in MPa | | | | | | | |
| Failure Type | Cohesive | Cohesive | Cohesive | Cohesive | Cohesive | Cohesive | Cohesive |
| DSC (min) | 20 | 16 | 7 | 12 | 15 | 22 | 30 |

TABLE 2

| | | | Control | Control | Control |
|---|---|---|---|---|---|
| Description | F # 8 | F # 9 | 1 | 2 | 3 |
| MOH-D-MOH (~30000 cPs | 22.63 | 22.63 | 22.63 | 22.63 | 22.63 |
| Viscosity) | | | | | |
| MOH-D-MOH (~3000 cPs | 24.1 | 24.1 | 24.1 | 24.1 | 24.1 |
| Viscosity) | | | | | |
| Silquest A-1170 (Amino-bis- | 1.8 | 1.8 | | | |
| silane) | | | | | |
| Silquest A-597 (Isocyanurate) | 0.9 | 0.9 | 1.0 | 1.0 | 1.0 |
| Silquest A-1110 (Aminosilane) | | | 1.0 | 1.0 | 1.0 |
| Crosslinker (NPS) - n- | 0.3 | 0.3 | 0.3 | 0.3 | 0.3 |
| Propylsilicate | | | | | |
| M-D-M (PDMS) ~10000 cPs | 4.58 | 2.51 | 5.47 | 5.47 | 5.28 |
| Viscosity | | | | | |
| Carbon Black | 1.21 | 1.21 | 1.21 | 1.21 | 1.21 |
| Calcium Carbonate (CaCO3) | 44.21 | 44.21 | 44.21 | 44.21 | 44.21 |
| PDMS-PPO Copolymer (~500 cSt | 0.04 | 0.04 | 0.04 | 0.04 | 0.04 |
| Viscosity) | | | | | |
| Additive 1 (H2O) | | | | | |
| Additive 2 (Versatic Acid) | | 0.26 | | | |
| Additive 3 (Silicone MQ Resin) | | 1.81 | | | |
| Catalyst | 0.23 Reaxis | 0.23 K- | 0.04 DBTO | 0.04 K- | 0.23 K- |
| | C3208 | KAT-651 | (Sn) | KAT-651 | KAT-651 |
| TFT (min) | 8 | 5 | 8 | >4 h | 35 |
| Bulk Hardness (Shore A) - 24 h | 23 | 34 | 29 | 30 | 16 |
| Stability - Ageing Study | >5 Days | >5 Days | Not | Not | Not |
| (70 C./5 D) | | | Stable | Stable | Stable |
| Adhesion Strength (Al/Al) in MPa | 0.5 | ND | 0.38 | ND | ND |
| Failure Type | Cohesive | ND | Cohesive | ND | ND |
| Adhesion Strength (Glass/PC) in | 0.17 | 0.66 | 0.64 | ND | ND |
| MPa | | | | | |
| Failure Type | Cohesive | Cohesive | Cohesive | ND | ND |
| DSC (min) | 17 | 5 | 10 | >24 h | >24 h |

In Tables 1 and 2, the catalysts designations refer to the following catalysts:
K-KAT-651=Bismuth Carboxylate
K-KAT-670=Zn Catalyst
K-KAT-648=Zn Complex+Alkanolamine
Reaxis C3208=Bismuth Carboxylate
TIB-KAT-519=Titanium ethyl acetoacetate
TIB-KAT-851=Aluminium ethyl acetoacetate
DBTO=dibutyl tin oxide

As shown in Tables 1 and 2, the compositions employing the additives show good adhesive properties including tack free time and deep section cure. In Table 1, the compositions using the titanium and aluminum catalysts had slightly higher tack free time sand deep section cure times. Again, the overall properties were still good. The selection of catalyst, therefore, may allow for control of certain properties (e.g., for conditions where faster tack free time or deep section cure may not be necessary or desirable). Example F #2 is similar to F #1 except that F #2 included water as an additive with the acid additive. This still provided excellent adhesion and slightly faster curing in terms of both tack free time and deep section curing.

### Examples F10-F13

Compositions were prepared with the formulas shown in Table 3. The compositions employ varying levels of MQ resin. As shown in Table 3, good deep section cure can be achieved with varying levels of MQ resin. Above 5% of MQ resin saw an increase in time to achieve deep section cure.

TABLE 3

| Description | F # 10 | F # 11 | F # 12 | F # 13 |
|---|---|---|---|---|
| MOH-D-MOH (~30000 cPs Viscosity) | 22.12 | 21.66 | 21.21 | 20.76 |
| MOH-D-MOH (~3000 cPs Viscosity) | 23.45 | 22.97 | 22.49 | 22.01 |
| Silquest A-1170 (Amino-bis-silane) | 0.80 | 0.80 | 0.80 | 0.80 |
| Silquest A-597 (Isocyanurate) | 0.40 | 0.40 | 0.40 | 0.40 |
| Silquest A-1120 (Aminosilane) | 0.40 | 0.40 | 0.40 | 0.40 |
| Crosslinker (NPS) - n-Propylsilicate | 0.27 | 0.27 | 0.27 | 0.27 |
| M-D-M (PDMS) ~10000 cPs Viscosity | 5.75 | 5.75 | 5.75 | 5.75 |
| Carbon Black | 1.22 | 1.22 | 1.22 | 1.22 |
| Calcium Carbonate (CaCO3) | 43.25 | 42.37 | 41.48 | 40.60 |
| PDMS-PPO Copolymer (~500 cSt | 0.04 | 0.04 | 0.04 | 0.04 |
| Viscosity) | | | | |
| Additive 1 (H2O) | 0.00 | 0.00 | 0.00 | 0.00 |
| Additive 2 (Versatic Acid) | 0.27 | 0.27 | 0.27 | 0.27 |
| Additive 3 (Silicone MQ Resin) | 1.82 | 3.64 | 5.45 | 7.27 |
| Catalyst (K-Kat-651) | 0.21 | 0.21 | 0.21 | 0.21 |
| Catalyst (Reaxis C-3208) | 0.00 | 0.00 | 0.00 | 0.00 |
| Total | 100 | 100 | 100 | 100 |
| TFT (min) | 6 | 6 | 8 | 9 |
| Bulk Hardness (Shore A) - 24 h | 31 | 31 | 29 | 28 |
| Stability - Ageing Study (70 C./5 D) | | | | |
| Adhesion Strength (Glass/Al) in MPa | 0.69 | 0.77 | 0.63 | NT |
| Failure Type | Cohesive | Cohesive | Cohesive | NT |
| Adhesion Strength (Glass/PC) in MPa | 0.64 | 0.66 | 0.69 | NT |
| Failure Type | Cohesive | Cohesive | Cohesive | NT |
| DSC (min) | 22 | 24 | 25 | 43 |

### Examples F F14-F17

Compositions were prepared with the formulas in Table 4. In the compositions of Table 4, the concentration of the acid additive (in this case Versatic acid) was adjusted. As shown in Table 4, excellent tack free time is achieved even at low concentrations of acid additive. Good deep section is also achieved with low concentrations of acid additive, and is shown to significantly improve with an increase in the amount of acid additive in the compositions.

TABLE 4

| Description | F #14 | F # 15 | F #16 | F #17 |
|---|---|---|---|---|
| MOH-D-MOH (~30000 cPs Viscosity) | 22.57 | 22.59 | 22.61 | 22.63 |
| MOH-D-MOH (~3000 cPs Viscosity) | 23.93 | 23.95 | 23.98 | 23.99 |
| Silquest A-1170 (Amino-bis-silane) | 0.80 | 0.80 | 0.80 | 0.80 |
| Silquest A-597 (Isocyanurate) | 0.40 | 0.40 | 0.40 | 0.40 |
| Silquest A-1120 (Aminosilane) | 0.40 | 0.40 | 0.40 | 0.40 |
| Crosslinker (NPS) - n-Propylsilicate | 0.27 | 0.27 | 0.27 | 0.27 |
| M-D-M (PDMS) ~10000 cPs Viscosity | 5.75 | 5.75 | 5.75 | 5.75 |
| Carbon Black | 1.22 | 1.22 | 1.22 | 1.22 |
| Calcium Carbonate (CaCO3) | 44.14 | 44.18 | 44.23 | 44.25 |
| PDMS-PPO Copolymer (~500 cSt | 0.04 | 0.04 | 0.04 | 0.04 |
| Viscosity) | | | | |
| Additive 1 (H2O) | 0.00 | 0.00 | 0.00 | 0.00 |
| Additive 2 (Versatic Acid) | 0.27 | 0.18 | 0.09 | 0.05 |
| Additive 3 (Silicone MQ Resin) | | | | |
| Catalyst (K-Kat-651) | 0.21 | 0.21 | 0.21 | 0.21 |
| Catalyst (Reaxis C-3208) | | | | |
| Total | 100 | 100 | 100 | 100 |
| TFT (min) | 4 | 5 | 6 | 8 |
| Bulk Hardness (Shore A) - 24 h | NT | NT | 36 | 31 |
| Stability - Ageing Study (70 C./5 D) | | | | |
| Adhesion Strength (Glass/Al) in MPa | NT | NT | 0.61 | 0.63 |
| Failure Type | NT | NT | Cohesive | Cohesive |
| Adhesion Strength (Glass/PC) in MPa | NT | NT | 0.64 | 0.72 |
| Failure Type | NT | NT | Cohesive | Cohesive |
| DSC (min) | 4 | 10 | 19 | 28 |

### Examples F18-F21

Compositions were prepared according to the formulations in Table 5. Examples FT8-F21 employ fumed silica and/or an alkyl polydimethylsiloxane (alkyl PDMS) filler. The alkyl polydimethyl siloxane is a wax material having 25-30 methyl substituted “D” units, and a C25-C30 alkyl terminal end group. Example F10 is included in Table 5 and does not contain the fumed silica or alkyl PDMS filler. Table 5 shows that good tack free time, hardness, and adhesion can be maintained with the addition of these fillers. Additionally, the inclusion of these fillers can improve deep section curing.

TABLE 5

| Description | F # 10 | F # 18 | F # 19 | F # 20 | F # 21 |
|---|---|---|---|---|---|
| MOH-D-MOH (~30000 cPs | 22.12 | 22.12 | 22.12 | 22.12 | 22.12 |
| Viscosity) | | | | | |
| MOH-D-MOH (~3000 cPs | 23.45 | 23.45 | 23.45 | 23.45 | 23.45 |
| Viscosity) | | | | | |
| Silquest A-1170 (Amino-bis- | 0.80 | 0.79 | 0.78 | 0.80 | 0.80 |
| silane) | | | | | |
| Silquest A-597 (Isocyanurate) | 0.40 | 0.39 | 0.39 | 0.40 | 0.40 |
| Silquest A-1120 (Aminosilane) | 0.40 | 0.39 | 0.39 | 0.40 | 0.40 |
| Crosslinker (NPS) - n- | 0.27 | 0.27 | 0.27 | 0.27 | 0.27 |
| Propylsilicate | | | | | |
| M-D-M (PDMS) ~10000 cPs | 5.75 | 5.68 | 5.63 | 5.75 | 5.75 |
| Viscosity | | | | | |
| Carbon Black | 1.22 | 1.21 | 1.20 | 0.77 | 0.77 |
| Calcium Carbonate (CaCO3) | 43.25 | 43.25 | 43.25 | 43.25 | 43.25 |
| HMDZ treated Fumed Silica* | | | 0.09 | | |
| Untreated Fumed Silica | | | | 0.45 | |
| DMDCS Treated Fumed Silica\hat{ } | | | | | 0.45 |
| Alkyl PDMS | | 0.11 | 0.11 | | |
| PDMS-PPO Copolymer (~500 cSt | 0.04 | 0.04 | 0.04 | 0.04 | 0.04 |
| Viscosity) | | | | | |
| Additive 1 (H2O) | | | | | |
| Additive 2 (Versatic Acid) | 0.27 | 0.27 | 0.27 | 0.27 | 0.27 |
| Additive 3 (Silicone MQ Resin) | 1.82 | 1.82 | 1.82 | 1.82 | 1.82 |
| Catalyst (K-Kat-651) | 0.21 | 0.20 | 0.20 | 0.21 | 0.21 |
| Catalyst (Reaxis C-3208) | | | | | |
| Total | 100 | 100 | 100 | 100 | 100 |
| TFT (min) | 6 | 5 | 4 | 8 | 6 |
| Bulk Hardness (Shore A) - 24 h | 31 | 30 | 30 | 31 | 31 |
| Stability - Ageing Study (70 C./5 D) | | | | | |
| Adhesion Strength (Glass/Al) in | 0.69 | 0.8 | 0.74 | 0.81 | 0.79 |
| MPa | | | | | |
| Failure Type | Cohesive | Cohesive | Cohesive | Cohesive | Cohesive |
| Adhesion Strength (Glass/PC) in | 0.64 | 0.75 | 1.11 | 1.02 | 0.71 |
| MPa | | | | | |
| Failure Type | Cohesive | Cohesive | Cohesive | Cohesive | Cohesive |
| DSC (min) | 22 | 13 | 15 | 16 | 16 |

*HMDZ = hexamethyldisilazane
\hat{ }DMDCS = dimethyldicholorsilane

### Examples F22-F28

Compositions were prepared according to the formulations in Table 6. The compositions similar to those of Table 1 except that compositions F22-F28 employ a combination of bis-silane adhesion promoter and an isocyanurate silane. Additionally, similar to the compositions in Table 1, different types of catalysts are employed in the compositions. The compositions exhibit good storage stability, adhesion, and deep section curing.

TABLE 6

| Description | F # 22 | F # 23 | F # 24 | F # 25 | F # 26 | F # 27 | F # 28 |
|---|---|---|---|---|---|---|---|
| MOH-D-MOH | 22.63 | 22.63 | 22.63 | 22.63 | 22.63 | 22.63 | 22.63 |
| (~30000 cPs | | | | | | | |
| Viscosity) | | | | | | | |
| MOH-D-MOH | 24.1 | 24.1 | 24.1 | 24.1 | 24.1 | 24.1 | 24.1 |
| (~3000 cPs | | | | | | | |
| Viscosity) | | | | | | | |
| Silquest A-1170 | 1.8 | 1.8 | 1.8 | 1.8 | 1.8 | 1.8 | 1.8 |
| (Amino-bis-silane) | | | | | | | |
| Silquest A-597 | 0.9 | 0.9 | 0.9 | 0.9 | 0.9 | 0.9 | 0.9 |
| (Isocyanurate) | | | | | | | |
| Silquest A-1110 | | | | | | | |
| (Aminosilane) | | | | | | | |
| Crosslinker | 0.3 | 0.3 | 0.3 | 0.3 | 0.3 | 0.3 | 0.3 |
| (NPS) - n-Propylsilicate | | | | | | | |
| M-D-M (PDMS) ~10000 | 4.14 | 3.97 | 4.14 | 4.14 | 4.25 | 4.14 | 4.14 |
| cPs Viscosity | | | | | | | |
| Carbon Black | 1.21 | 1.21 | 1.21 | 1.21 | 1.21 | 1.21 | 1.21 |
| Calcium Carbonate | 44.21 | 44.21 | 44.21 | 44.21 | 44.21 | 44.21 | 44.21 |
| (CaCO3) | | | | | | | |
| PDMS-PPO Copolymer | 0.04 | 0.04 | 0.04 | 0.04 | 0.04 | 0.04 | 0.04 |
| (~500 cSt | | | | | | | |
| Viscosity) | | | | | | | |
| Additive 1 (H2O) | | | | | | | |
| Additive 2 | 0.44 | 0 | 0.22 | 0.22 | 0.22 | 0.22 | 0.22 |
| (Versatic Acid) | | | | | | | |
| Additive 3 | | | | | | | |
| (Silicone MQ Resin) | | | | | | | |
| Catalyst | 0.23 K- | 0.23 K- | 0.23 K- | 0.23 K- | 0.23 K- | 0.04 TIB- | 0.04 TIB- |
| | KAT-651 | KAT-651 | KAT-651 | KAT-670 | KAT-648 | KAT-519 | KAT-851 |
| TFT (min) | 5 | 8 | 6 | 6 | 7 | 13 | 15 |
| Bulk Hardness | 29 | 30 | 30 | 30 | 29 | 30 | 31 |
| (Shore A) - 24 h | | | | | | | |
| Stability - Ageing Study | >5 Days | >5 Days | >5 Days | >5 Days | >5 Days | >5 Days | >5 Days |
| (70 C./5 D) | | | | | | | |
| Adhesion Strength | 0.23 | 0.39 | 0.59 | 0.29 | 0.40 | 0.34 | 0.40 |
| (Al/Al) in MPa | | | | | | | |
| Failure Type | Adhesive | Cohesive | Cohesive | Adhesive | Cohesive | Cohesive | Cohesive |
| Adhesion Strength | 0.25 | 0.24 | 0.28 | 0.34 | 0.25 | 0.25 | 0.51 |
| (Glass/PC) in MPa | | | | | | | |
| Failure Type | Adhesive | Adhesive | Adhesive | Adhesive | Adhesive | Adhesive | Cohesive |
| DSC (min) | 10 | 26 | 12 | 15 | 14 | 35 | 34 |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a curable polyorganosiloxane composition. Modifications may occur to those skilled in the art and to those who may make and use the invention. The disclosed embodiments are merely for illustrative purposes and not intended to limit the scope of the invention or the subject matter set forth in the claims.

1. A condensation curable silicone composition comprising:
(i) an organopolysiloxane comprising a condensation curable and/or a hydrolyzable functional group;
(ii) a crosslinker
(iii) a non-tin, metal-based catalyst comprising a metal center and an organic ligand, the organic ligand present in a molar amount sufficient to balance the charge of the metal center;
(iv) an adhesion promoter comprising (a) a first adhesion promoter selected from a secondary amino silane, and (b) a second adhesion promoter other than a secondary amino silane; and
(v) an additive selected from an organic acid, water, or a combination thereof.

2. The condensation curable silicone composition of claim 1, wherein the second adhesion promoter is selected from a primary amino silane, a tertiary amino silane, a cyanurate, an isocyanurate, or a combination of two or more thereof.

3. The condensation curable silicone composition of claim 1, wherein the secondary amino silane is selected from a compound of the formula: 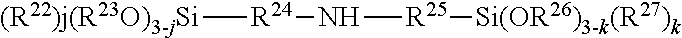
R²², R²³, R²⁶, and R²⁷ are independently selected from a C1-C20 monovalent hydrocarbon; R²⁴ is selected from a divalent C1-C20 hydrocarbon; and j and k are independently selected from 0-2.

4. The condensation curable silicone composition of claim 3, wherein the secondary amino silane is bis(gamma-trimethoxysilylpropyl) amine.

5. The condensation curable silicone composition of any claim 2, wherein the second adhesion promoter is selected from an aminoalkyltrialkoxysilane, an aminoalkyl(alkyldialoxysilane), a tris(alkyltrialkoxysilyl)amine, a N(beta-aminoalkyl)-gamma-aminoalkyl trialkoxysilane, a N(beta-aminoalkyl)-gamma-aminodialkyl dimethoxysilane, a tris(alkyltrialkoxysilyl)cyanurate, a tris(alkyltrialkoxysilyl)isocyanurate, or a combination of two or more thereof.

6. The condensation curable silicone composition of claim 1, wherein the adhesion promoter (iv) is present in an amount of from about 0.1 wt. % to about 10 wt. % based on the total weight of the composition.

7. The condensation curable silicone composition of claim 1, wherein the first adhesion promoter is present in an amount of 0.05 wt. % to about 9.95 wt. % based on the total weight of the composition, and the second adhesion promoter is present in an amount of from about 0.05 wt. % to about 9.95 wt. % based on the total weight of the composition.

8. The condensation curable silicone composition of claim 1, wherein the metal center of the metal-based catalyst is selected from bismuth, zinc, titanium, aluminum, or zirconium

9. The condensation curable silicone composition of claim 1, wherein the organic ligand of the non-tin, metal-based catalyst is selected from a C4-C30 carboxylate.

10. The condensation curable silicone composition of claim 9, wherein the organic ligand is neodecanoate.

11. The condensation curable silicone composition of claim 1, wherein the non-tin, metal-based catalyst is present in an amount of from about 0.001 wt. % to about 2.5 wt. % based on the total weight of the composition.

12. The condensation curable silicone composition of claim 1, wherein the organic acid is selected from a C4-C30 organic acid.

13. The condensation curable silicone composition of claim 1, wherein the organic acid is selected from at least neodecanoic acid.

14. The condensation curable silicone composition of claim 1, wherein for the additive (v), the organic acid can be present in an amount of from about 0 wt. % to about 2 wt. %, and water can be present in an amount of from about 0 wt. % to about 1 wt. %, with the proviso that the wt. % of organic acid+the wt. % of water is greater than 0.

15. The condensation curable silicone composition of claim 1, wherein the additive (v) is provided as a diluent for the non-tin, metal-based catalyst.

16. The condensation curable silicone composition of claim 1, wherein the organopolysiloxane is selected from a silanol-functional organopolysiloxane.

17. The condensation curable silicone composition of claim 1, wherein the organopolysiloxane comprises a first silanol functional organopolysiloxane having a viscosity of from about 100 to about 12,000 mPa·s, and a second silanol functional organopolysiloxane having a viscosity of from about 15,000 to 100,000 mPa·s.

18. The condensation curable silicone composition of claim 1, wherein the organopolysiloxane is present in an amount of from about 5 wt. % to about 95 wt. % based on the total weight of the composition.

19. The condensation curable silicone composition of claim 1 comprising a metal oxide.

20. The condensation curable silicone composition of claim 19, wherein the metal oxide is selected from an untreated fumed silica or a fumed silica comprising a surface treatment.

21. The condensation curable silicone composition of claim 20, wherein the silica is selected from a fumed silica comprising a surface treatment selected from an organosilane, an organosilazane, or a diorganocyclopolysiloxnae.

22. The condensation curable silicone composition of claim 19, wherein the silica is present in an amount of from about 0.05 wt. % to about 2 wt. % based on the total weight of the composition.

23. The condensation curable silicone composition of claim 1 comprising a MQ resin, where the MQ resin is present in an amount of from about 0.1 wt. % to about 10 wt. % based on the total weight of the composition.

24. The condensation curable silicone composition of claim 1, wherein the composition is provided as a two-part composition comprising: (a) a first part comprising the organopolysiloxane, and (b) a second part comprising the adhesion promoter, the crosslinker, the catalyst, and the additive.

25. A method of forming a cured material comprising exposing the condensation curable silicone composition of claim 1 to moisture.
